(19) United States
(12) Patent Application Publication
(10) Pub. No.: US 2016/0378817 A1
(43) Pub. Date: Dec. 29, 2016

(54) SYSTEMS AND METHODS OF IDENTIFYING DATA VARIATIONS

(71) Applicant: Trifectix, Inc., Cedar Park, TX (US)

(72) Inventors: Robin Fuller, Round Rock, TX (US); Joe Senner, Georgetown, TX (US); Timothy Wall, Georgetown, TX (US); Kristy McDougal, Austin, TX (US)

(73) Assignee: TRIFECTIX, INC., Cedar Park, TX (US)

(21) Appl. No.: 14/750,594

(22) Filed: Jun. 25, 2015

(51) Int. Cl. G06F 17/30; G06F 3/0481

(52) U.S. Cl. CPC G06F 17/30371; G06F 17/30424; G06F 3/0481

(57) ABSTRACT

Systems and methods are provided for identifying data variations, which can include normalizing and validating data. In some embodiments, normalizing data may include converting the data from a first format into a second selected format. Data may also be validated by comparing the data to a rule set. Normalized data may be examined on a line-by-line basis, with each line of the normalized data checked for compliance with rules of the rule set. Compliance data identifying the results of comparing the data against the rule set may be generated and output.

### BACKGROUND

Computing and data management systems may handle large volumes of data. Data sets may include interrelated data elements, and certain information may be required to conform to particular rule sets, data range requirements, data types, data dependencies, other requirements, or any combination thereof. When dealing with complex and numerous systems, the amount of data to be verified and validated may become significant to the level that it is not possible, or exceptionally difficult, to manage it manually.

### SUMMARY

In some embodiments, a system may include a processor configured to compare configuration data to a rule set, generate compliance data based on the results of the comparison, and generate a report including the compliance data.

In another embodiment, a memory device may store instructions that, when executed, cause a processor to perform a method including normalizing unverified data by converting the unverified data to a selected format, determining compliance data for the unverified data based on a rule set, and reporting the results of the determination.

In yet another embodiment, a method may include normalizing unverified data by converting the unverified data to a selected format at a normalization module, determining compliance data for the unverified data based on a rule set at a rules module, and reporting the results of the determination via an interface.

### BRIEF DESCRIPTION OF THE DRAWINGS

FIG. 1 is a block diagram of a system configured to identify data variations, in accordance with certain embodiments of the present disclosure;

FIG. 2 is a flowchart of a method of identifying data variations, in accordance with certain embodiments of the present disclosure; and

FIG. 3 is a flowchart of a method of identifying data variations, in accordance with certain embodiments of the present disclosure.

### DETAILED DESCRIPTION

In the following detailed description of the embodiments, reference is made to the accompanying drawings which form a part hereof, and in which are shown by way of illustrations. It is to be understood that features of the various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

In accordance with various embodiments, the methods and functions described herein may be implemented as one or more software programs running on a computer processor or controller circuit, or running on a computing device such as a tablet computer, a smartphone, a personal computer, a server, any other computing device, or any combination thereof. Dedicated hardware implementations including, but not limited to, application specific integrated circuits, programmable logic arrays, and other hardware devices can likewise be constructed to implement the methods and functions described herein. Further, the methods described herein may be implemented as a device, such as a nonvolatile computer readable storage medium or memory device, including instructions that, when executed, cause a processor to perform the methods.

In some embodiments, computing systems may handle large amounts of data. The data may include configuration data for designating settings for computing systems, archival data for storage in databases, instructions for execution on specified devices, and so on. In some embodiments, the data may be in other forms or have other uses, or any combination thereof. For example, an administrator of a network may provide configuration data to configure one or more devices or software (e.g. operating systems, middleware, or other software applications) coupled to a network. In some instances, data may be received in a first format and may be processed, or “normalized” into a second format.

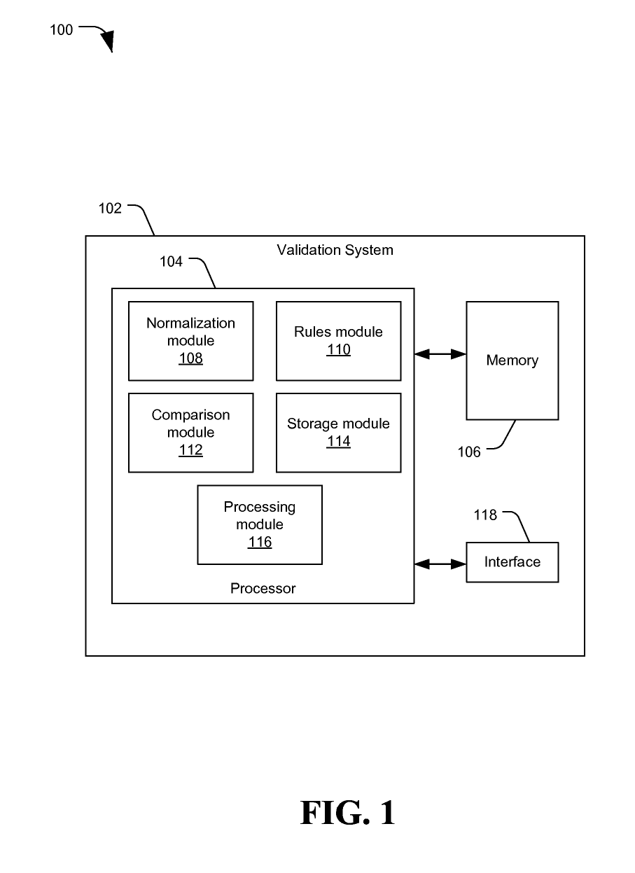

In some embodiments, the data may need to be verified as being accurate or conforming with the specified parameters. Embodiments of systems and methods are described below that may identify data variations. Identifying data variations may include normalizing data, verifying or validating received data, or both. An example of a system that may be configured to identify data variations is described below with respect to FIG. 1.

FIG. 1 is a block diagram of a system 100 configured to identify data variations, in accordance with certain embodiments of the present disclosure. System 100 may include a validation system 102, which may be a computing device such as a desktop or laptop computer, a server, a workstation, a personal electronic device such as a telephone or tablet, a computing cluster, another electronic data processing device, or any combination thereof. In some embodiments, validation system 100 may include a processor circuit 104 coupled to a memory 106 and to an interface 118. In some embodiments, validation system 102 may also include a housing or casing to physically contain the components of validation system 102 in a single device.

The interface 118 may include any wired or wireless communication interface configured to communicate data to and receive data from other devices, a network, etc. For example, the interface 118 may include an Ethernet port, a wireless transceiver (for short-range or long-range radio frequency data communication), a Universal Serial Bus (USB) port, or any other communications interface. In some embodiments, the interface 118 may be coupled to user input-output (I/O) devices, such as via USB cable or USB device. The interface 118 may be used to communicate data to other computing devices, either directly through a wired or wireless communication link or through a network. The validation system 102 may receive data via the interface 118, and may normalize and perform validation operations on the received data.

The processor 104 of validation system 102 may include one or more central processing units (CPUs), field programmable gate arrays (FPGAs), application-specific integrated circuits (ASICs), other data processing circuits, or any combination thereof. The processor 104 may also include hardware modules, software modules, or a combination thereof, configured to define the operations of the validation system 102. A “module” may be a computing device or program configured to perform a particular task or job. For example, a module may include a set of computer instructions that, when executed, cause a processor to perform a specific task or set of tasks. Similarly, a module may include one or more circuits specifically configured to perform a specified task or set of tasks. The processor 104 may execute mathematical calculation operations, data storage and retrieval operations, data modification or manipulation operations, other operations of the validation system 102, or any combination thereof. In some embodiments, the processor 104 may include a normalization module 108, a rules module 110, a comparison module 112, a storage module 114, and a processing module 116.

The normalization module 108 may be used to perform normalization operations, including recognizing different types of data, and converting data into a selected format for further processing by the system 100. Normalizing operations may include operations to convert data from a first format into a selected format, which may be called a normalized or standardized format. In some embodiments, data files may be received in a variety of file formats. For example, the validation system 102 may be configured to receive and process data in multiple formats, such as data from different database management applications or data structures (e.g., .xml extensible markup language). Data may be structured with different data types, different memory or transmission formats, or other variations. For example, particular data fields may be received in a variety of formats (e.g., date fields of database entries may be in formats such as MM/DD/YYYY, YYYY/MM/DD, MM.DD.YY, etc.). In another example, data fields may be arranged in different orders, and the normalization module 108 may be configured to recognize the data types and to reorganize the data into a selected data arrangement. The normalization module 108 may be configured to recognize a variety of data formats based on the different characteristics of those data formats. For example, the different formats may employ different file types, may include different data headers or identifiers, may include different variable sizes or types, may have different variations, or any combination thereof. Normalization operations may convert data from the format in which it was received into a selected standard format.

In an example embodiment, the validation system 102 may receive configuration data for adjusting or selecting settings of a computing device or software application. The data may be received in a variety of file formats, which may be identified by the file extension following a file name. For example, configuration data may be received as xml files, ini files, conf files, config files, csv files, other formats, or any combination thereof. In some embodiments, the configuration data may be received in a raw data format received from an application program interface (API). For example, some received data may be stored in a file of a first format, and additional data may be extracted from an API associated with a device from which the data was received in a second format. The normalization module 108 may include or may communicate with a database or list of recognized file formats.

When data is received by the normalization module 108, it may compare the format of the received data to the recognized data formats to determine if the data can be normalized. In an example, the normalization module 108 may compare a file extension of the data to file extension in the recognized file formats. In some embodiments, the normalization module 108 may be configured to access instructions associated with each recognized format for extracting relevant information from the received data and converting the extracted information into a selected (standard) format. For example, a standardized format for a piece or element of configuration data may include: [source][location][setting]=[value(s)]. “Source” may indicate an application or device from which the data was received, a format in which the data was received, or other source identifying information. “Location” may include information identifying a location for the “setting” information within the source, such as where there data may be found in a file or how the data may be obtained from an API. “Setting” may identify the type of configuration setting the data modifies, such as a memory allocation size limit for a software application. “Value” may identify the value or selection for the identified “setting,” such as selecting a memory allocation size limit of “512” KB (kilobytes). In some embodiments, a particular setting may have none, one, or many values. Other embodiments are also possible.

In some example embodiments, the validation system 102 may receive data via the interface 118 from a user I/O device or from another computing device. In some embodiments, the validation system 102 may receive a command or instruction via the interface 118 to retrieve specified data from the memory 106. In another embodiment, the validation system 102 may query one or more devices on a network to retrieve data from the devices (for example, configuration settings of the devices). For example, other devices on a network may include an “agent” application or driver running on the device, which can gather and return requested data. The normalization module 108 may analyze the data to determine if the data is in a recognized format. When the received data is in a recognized format, the normalization module 108 may be configured to convert the data into a selected format and structure. In some embodiment, the normalization module 108 may extract data, transform the data into a suitable format, and load the data into fields of a table or database. Thus, the normalization module 108 may convert the data into a defined data structure or format, which can then be further processed to perform various operations. By converting data into a normalized format, a single set of validation rules or constraints may be applied to the normalized data. Performing validation operations on standardized data sets can improve performance of a computing system by avoiding the need to verify or validate data in many different formats. In some embodiments, normalized data may be passed to the rules module 110 for validation.

The rules module 110 may store, access, apply, and otherwise manage a set of rules used to validate data. Validation operations may include operations to determine whether data is accurate or whether the data conforms to one or more rules. The rules module 110 may identify pieces of data that are important or that require validation, the expected or permissible values for different pieces of data, and relationships between values of different pieces of data. The rules module 110 may be configured to act on normalized data previously processed by normalization module 108. In some embodiments, new normalized data may be compared against data stored in the memory 106 (or in an external database) as part of normalization or validation operations on the new data. In some embodiments, the rules module 110 may act on data that has not been processed by the normalization module 108, for example, if the data is received from a source known to provide data in an expected or selected format. Other embodiments are also possible.

After performing validation operations, the rules module 110 may output compliance data including the results of the validation operations. For example, compliance data may include a list of results for each applied rule or for each line of data, including whether the data was compliant, what rules were violated by which data, other information, or any combination thereof.

The rules applied by rules module 110 may be user-selected (e.g. by a rules administrator for a network), such as by having a user create a rule set prior to executing operations at the rules module 110. In some embodiments, the rules system 110 may learn rules during operation, such as by submitting a query to a user device to determine how to handle an unexpected data element, and then storing the response as a new rule. In some embodiments, received data may be compared against a “template” data set, such as the configuration data of a selected device or application, to ensure new data matches the template. In some embodiments, rules may be designated by other sources. For example, a database management system may include a pre-defined instruction set for migrating and merging data from other database systems. Other embodiments are also possible.

In some embodiments, the rules module 110 may determine whether a certain piece of data matches or corresponds to a related piece of data in an expected way. The rules module 110 may identify, based on a rule set, the correct and incorrect values or ranges for a datum. In some embodiments, rules may stipulate that correct data values or ranges may be gathered from other pieces of data. Some rules may direct that data must be a static value or range of values, must equal the sum or count of other data, must follow other constraints, or any combination thereof.

In some embodiments, rules may stipulate that one data value must, or must not, equal the value from another piece of data. In an example embodiment, the “social security number” fields of two database entries must match if the data is to be merged, or an “ending date” field must not match or predate a “starting date” field. For example, the rules module 110 may determine whether a “name” field of a database entry matches a “name” field of a related database entry (e.g. for two database entries tied to the same customer number or similar identifier). In another example, the rules module 100 may determine whether a “ZIP code” field correctly corresponds to a “city” field or a “State of residence” field (e.g. the ZIP code designates a region within the State identified in the State of residence field). In another example, the rules may designate that an “age” field of a database entry must include numeric characters only, and that the value of the “age” field may not be less than 1. In another example, a received configuration setting for a device or application must match a configuration setting of a template device or application which is known to operate to desired specifications. Other examples are also possible.

In some embodiments, validation rules, valid parameter values, or example or template data sets may be obtained from systems external to validation system 102. For example, rules module 110 may receive shipping information to validate. One of the parameters may indicate a destination country as “Country_X”. The validation rules executed by rules module 110 may include performing a “FetchRestrictedCountryList” function, which performs a query to an external system. For example, the rules module 110 may initiate a query to a government website or database including a list of countries having shipping restrictions. The rules module 110 may then compare “Country_X” against the retrieved restricted country list to determine if “Country_X” is a valid parameter value. In some embodiments, the results of a “FetchRestrictedCountryList” may be stored as a template or sample configuration data set. Received shipping data may be compared against the FetchRestrictedCountryList data set to verify that there is no match with the destination country parameter of the data set being validated. Other embodiments are also possible.

In some embodiments, different rule sets may be applied to different types of data sets. For example, some rules may correspond to configuration data, some may correspond to customer data, some may correspond to financial transactions, and some may correspond to a listing of stored media content, with each data type having a different set of rules to be applied by the rules module 110. The type of data set being handled may be automatically identified by, e.g. the normalization module 108 or the rules module 110, may be specified by a user or system providing the data set, may be determined in another manner, or any combination thereof.

In some example embodiments, rules module 110 may output compliance data for a set of normalized data. In some embodiments, if the normalized data does not comply with all the rules of an applied rule set, a notification may be provided to the device from which the normalized data was received requesting correction to comply with the rules. In some embodiments, a notification of non-compliance may be provided to another device, such as an administrator device. The rules module 110 may then generate new compliance data for the received modified normalized data.

The comparison module 112 may be configured to perform comparisons between normalized data sets, between compliance data sets, between other data, or any combination thereof. For example, the comparison module 112 can compare differences between sets of compliance data, as well as differences between sets of normalized data. The comparison module 112 may compare new compliance data to previous compliance data to determine whether the latest set of normalized data is more compliant with the rules than previous normalized data. For example, successive sets of compliance data may be compared to determine if data sets are becoming more or less compliant with each successive iteration. The comparison module 112 may determine the data elements that were properly corrected, or whether any data elements now violate the rules that previously did not. Other comparisons are also possible.

Similarly, in some embodiments sets of normalized data from the normalization module 108 may be compared by comparison module 112 to determine changes or differences between the sets. In an example embodiment, one or more elements of a first set of normalized data may be compared against one or more elements of a second set of normalized data. For example, two sets of related normalized data (e.g. applying to the same customer or database entry) may be merged together prior to undergoing a validation operation. The comparison module may determine which data elements match (and may therefore be duplicative or correspond to the same piece of datum) and can be combined. After comparison and merging, only a single set of data may be validated at the rules module 110 instead of two sets. In some embodiments, related normalized data can be compared to ensure that data elements which should match do, in fact, match. For example, a new database entry regarding a customer may be compared against an existing database entry for the same customer. For example, the comparison module 112 may determine whether a “name” field of new normalized data matches a “name” field of a data entry stored to a database, by obtaining the stored data entry, extracting the “name” field data, and performing a comparison between the new “name” field and the stored “name” field. In some embodiments, only new data elements that do not match existing data elements may be processed by the rules module 110. For example, data elements which match elements that have already undergone a verification process may not need to be verified again. As an example, a first set of configuration data may be received, and compliance data may indicate that not all rules were complied with. The comparison module 112 may compare a subsequent set of compliance data to the first set to determine which elements, if any have changed, and only the changed elements may be provided to the rules module 110 for analysis. Other embodiments are also possible.

The storage module 114 may store data to and retrieve data from storage media, such as memory 106, another data storage device internal or external to the validation system 102, other memory devices, or any combination thereof. For example, the storage module 114 may retrieve data from the memory 106 and provide the data to the rules module 110 or to comparison module 112. The storage module 114 may store rules, for example as defined by a user, for use by the rules module 110, or may store information about recognized data formats for use by the normalization module 108. The storage module 114 may store data sets that have been determined to comply with the rules of rules module 110. For example, if a set of data has undergone normalization at normalization module 108, and has complied with an applied rule set at rules module 110, the processor 104 may use the storage module 114 to store the set of data, the compliance data from rules module 110, or both, to the memory 106. In some embodiments, the storage module 114 may store any error reports or other indications of non-compliant data to memory 106, such as compliance data for a set of data that did not comply with an applied rule set. In some embodiments, the storage module 114 may be used to relate data to the source of the data. For example, the storage module 114 may relate data to a source by storing received data to a directory reserved for the provider of the data, by appending metadata identifying a source of the data before saving the data, by storing the data to a relational database to create a relational connection with the data source, by other methods, or any combination thereof.

The processing module 116 can be used for performing a variety of processing and computational tasks for the validation system 102. For example, the processing module 116 may accept data of various formats and execute module instructions to implement normalization, rule application, comparison, and storage operations. For example, the normalization module 108, rules module 110, comparison module 112, and storage module 114 may be sets of processor instructions (or applications), and the processing module 116 may execute the various instructions to perform the processing to carry out the features and functions of the other modules. In some embodiments, the other modules may be dedicated circuits or processors (or may be executed by dedicated circuits or processors), which may access or use the processing module 116 to perform computations or to provide additional processing power.

In some embodiments, the processing module 116 manages the flow of data to and from the other modules, or regulates the operation of the other modules. In some embodiments, the processing module 116 can make available to a user the compliance data results obtained by running normalized data through the rules module 110. As previously discussed, compliance data may include a compilation of results identifying what data or data elements complied with rules applied by rules module 110, which data or data elements did not comply with the rules, the reasons for non-compliance or violated rules for each data or data element, other results information, or any combination thereof. In some embodiments, the processing module 116 can make compliance data available in a number of ways, such as via a web-browser, via email, directly through interface 118, via notification in another form, or any combination thereof. The compliance data may be included in a report or other document, which may also include additional information such as suggested remedial measures to correct non-compliant data. In some embodiments, validation system 102 may generate a graphical user interface (GUI) to provide the compliance data. Other embodiments are also possible.

Memory 106 of validation system 102 may include one or more volatile or non-volatile data storage devices, or any combination thereof. In some embodiments, memory 106 may store data and may store processor-readable instructions that, when executed, may cause processor 104 to perform the methods and operations described herein. In some embodiments, memory 106 may be external to validation system 102. In some embodiments, memory 106 may include data of one or more databases, which may be accessed by validation system 102. For example, the validation system 102 may retrieve data from the memory 106 and perform normalizing operations, validation operations, other operations, or any combination thereof on the data.

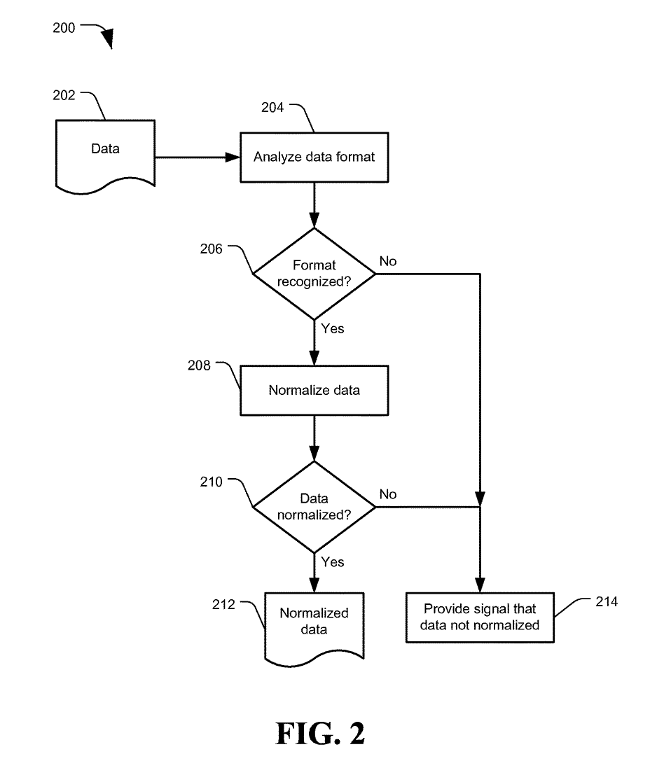

The validation system 102 may be configured to receive, normalize, and validate data or data sets, using the processor 104, various modules, and other components. For example, the validation system 102 may normalize and validate the data prior to storage to a database. Furthermore, the validation system 102 can be used to validate changes or updates that a user may wish to apply to devices, to applications, to other data sets, or to any combination thereof. By analyzing the changes using the rules module 110, the changes can be validated prior to becoming finalized (e.g. prior to being stored in a database or put into effect on a system). An example method for normalizing data is depicted in regards to FIG. 2.

FIG. 2 depicts a flowchart of a method 200 of normalizing data, in accordance with certain embodiments of the present disclosure. In some embodiments, method 200 may be performed by a validation system, such as validation system 102 of FIG. 1. Method 200 may include receiving data, at 202. The data may include individual data elements, multiple data elements, update data, configuration data, instructions, other data, or any combination thereof.

Method 200 may include analyzing a data format of the received data, at 204. For example, at various times, the received data may be in multiple different formats, such as different file types, different data structures or organization, different file sizes, other format variations, or any combination thereof. For example, the format of data may refer to the structure or arrangement of the data. e.g., how data is recorded in the fields of a database entry. In an example embodiment, formats of a “date” database field may include MM/DD/YYYY, [Month name] [date], [year], or other formats. Recognized date formats may be converted into a selected format of YYYY/MM/DD. Other embodiments are also possible.

At 206, the method 200 may include determining whether the data is in a format compliant with or recognized by the system. For example, a validation system 102 may be configured to recognize data provided in selected data formats, and may not recognize or include instructions to process data in other formats. If the data format is not recognized, at 206, the method 200 may include providing a signal or notice that the data was not normalized, at 214. For example, a failure signal or message may be generated and returned to the source of the data or to another device. The generated signal may be in the form of a message, alert, or notice directed to a user, such as an e-mail, text message, telephone recording, graphical signal or indicator displayed at a screen, another alert, or any combination thereof. In some embodiments, the signal may include a visualization. In some embodiments, the signal may be provided to a computing device, recorded in a log file, stored in a memory, or otherwise provided. In some embodiments, the signal may include instructions to a user or computing device, for example, instructions including corrective actions to perform.

If the data format is recognized, at 206, the method 200 may include normalizing the data, at 208. For example, the normalization module 108 of validation system 102 may include instructions that may cause a processor to convert the data from a first format into a selected “normalized” format. In some embodiments, at least some of the received data of any recognized format may be converted into the selected format for processing by a validation system 102. In some embodiments, the data may be received, at 202, in the selected format, and normalization operations may be skipped. In some embodiments, at least some of the recognized formats may be “high level” data formats understandable to human users, such as data elements composed of alphanumeric characters. For example, the high level data may be entered by a user via a user interface or may be extracted from a data file. In some embodiments, recognized formats may include file formats recognized by other applications or systems, such as files ending in extensions such as “.doc”, “.txt”, “.pdf”, or other file extensions. In some embodiments, the selected standard or normalized format may be a “low-level” machine- or computer-readable format (e.g. data represented in a specifically-configured bit string), or one that is specifically designed for processing by the validation system 102. In some embodiments, the selected normalized format may include the content of individual data fields structured in a specified manner (as in the date examples, above). Other embodiments are also possible.

The method 200 may include determining whether the data has been normalized, at 210. If the data was not successfully normalized (for example if an error was encountered during the normalization operation (at 208)), the method 200 may include providing a signal that the data was not normalized, at 214. If the data was successfully normalized, at 210, the method 200 may further include outputting the normalized data, at 212. For example, the normalized data may be passed to a rules module 110 to determine if the data complies with specified rules. In some embodiments, the normalized data may be passed to a storage module 114 for storage to a memory. In some embodiments, the normalized data may be returned to the user or system that provided the data or to another system. Other embodiments are also possible.

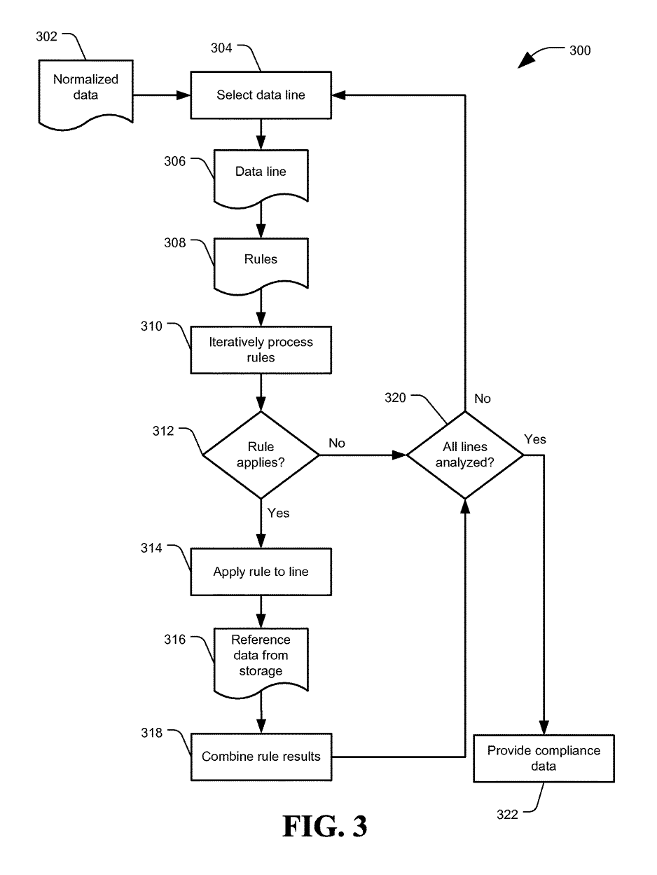

The normalized data may be compared to other data. In particular, once the data is organized into a selected format, the data may be compared to other similarly organized data. Additionally, once the data has been normalized, the normalized data may be validated for compliance with a specified rule set as discussed below with respect to FIG. 3.

FIG. 3 is a flowchart of a method 300 of validating data, in accordance with certain embodiments of the present disclosure. In some embodiments, method 300 may be performed by a validation system, such as validation system 102 of FIG. 1. Method 300 may include receiving normalized data, at 302. For example, the normalized data may be provided by a normalization module 108 after performing the method of FIG. 2. In some embodiments, the data may not be normalized (e.g. it may not need to be converted from a first format into a standard or normalized format). The data may include one or more data elements, including configuration data, instructions, update data, other data, or any combination thereof.

Method 300 may include selecting a data line, at 304. For example, the method 300 may include analyzing the data line-by-line, and determining one or more rules that may apply to each line. In some embodiments, rather than segmenting the data line-by-line, the data may be segmented by data elements, data fields, data chunks of a specified size, other data segments, or any combination thereof. For example, the data may include a set of configuration parameters for middleware running on one or more networked devices. Selecting data lines, at 304, may include iteratively selecting and processing each parameter or setting. In some embodiments, iteratively selecting data elements may include the repetition of a sequence of computer instructions (e.g. selecting a data line and applying to following method elements) a specified number of times or until a condition is met. For example, the condition may be when all the data lines have been analyzed, or until some threshold number of data lines are determined to not comply with a rule set, some other condition, or any combination thereof.

The method 300 may further include analyzing the selected data line, at 306. The method 300 may include retrieving rules that may apply to the selected data line, at 308. For example, one or more rules may be retrieved from a database, or accessed from a memory device. An applicable rule set may be selected based on the format of the data, based on a selected application for the data, or based on some other criteria. In some embodiments, the data may be compared to all stored rules, and method 300 may not include retrieving any particular rule set.

Method 300 may include iteratively processing at least some of the rules, or an applicable subset of the rules, at 310. For example, iteratively processing the rules may comprise comparing every rule in a rule set, or some subset of the rule set, to the selected data line to determine if the rule applies to the data line. In some embodiments, each rule may correspond to a specified configuration parameter, database field, or other data line identifier. For example, the current data line may include a “date” database field, and rules applicable to “date” fields may be retrieved and applied. In some embodiments, the data may include configuration settings, and the rules may include permissible or specified values or value ranges for each configuration setting. In some examples, the normalized data may include a financial transaction database entry, and a set of rules applicable to financial transaction database entries may be retrieved. Other examples are also possible. By iteratively comparing the rules to the selected data line, any rules applicable to a given data line may be determined.

The method 300 may include determining if any rule applies to the selected data line, at 312. If one or more rules apply, the method 300 may include applying one or more rules to the selected data line, at 314. In some embodiments, applying one or more rules to the selected data line may include determining whether the selected data line complies with each rule, and may include outputting results corresponding to the determination. In some embodiments, the output may include a data line identifier, a rule identifier, and a decision output (i.e., “complies” or “does not comply”). In some embodiments, applying the rule to the selected data line may include automatically applying corrective measures if the error may be corrected without user verification (e.g. if the rule requires a “State of residence” field to list the full name of the state, the method 300 may include automatically converting “VA” to “Virginia”, “FL” to “Florida”, or “Tex” to “Texas”). In some embodiments, such automatic conversions may be performed as part of a normalization operation instead of as part of the validation operation. In some embodiments, applying a rule to a selected data line may include retrieving reference data from data storage, at 316. For example, if the rules require that certain data elements or fields of the normalized data must match or correspond to reference data, applying the rules at 314 may require retrieving stored data at 316 to perform a comparison operation.

The method 300 may include combining the results of applying one or more rules to the data line to obtain compliance data, at 318. Compliance data may identify what data or data elements do or do not comply with at least one of the applied rules. For each data line to which one or more rules are applied at 314, the results of applying the one or more rules may be added to the compilation of results at 318. For example, if the selected data line is found to comply with the rules, an indication of compliance for the selected data line may be added to the compliance data. If the selected data line does not comply with the rules, an indication of non-compliance, and optionally an indication of which rules were not complied with, may be added to the compilation of results. In some embodiments, only indications of non-compliance are added to the compliance data, and compliant data is excluded. As an example, if a rule stipulates that a data field may only include numeric characters, the inclusion of one or more letters in the field may generate an indication of non-compliance. A corresponding entry may be added to the compliance data, at 318. Generating compliance data may include generating an alert, a list, a file, a document, or other compilation of the results of applying the rules to each line of data from the normalized data.

After combining rule results at 318, the method 300 may include determining if all data lines have been analyzed, at 320. If not, the method 300 may repeat, at 304. If all lines have been analyzed, the method 300 may include providing the compiled compliance data, at 322. The compliance data may be provided to a user or system that provided the data for verification, or may be provided to another system or component. For example, the compliance data may be provided in an e-mail, a text message, printout, or in another user-readable format. In some embodiments, the compliance data may be stored to a memory device. In some embodiments, the compliance data may be provided as one or more data packets or signals to another computing device. For example, a component of the validation system 102 may receive the compliance data and determine whether the data has complied with all rules and can be stored, implemented, transmitted, or executed, or otherwise put to a selected use for the data. Alternately, the validation system 102 may determine, based on the compliance data, whether the data or parts thereof must be corrected or replaced before the data is compliant. Other embodiments are also possible.

If no rule applies to the current data line, at 312, the method 300 may determine if all data lines have been analyzed, at 320. If some of the data lines have not been analyzed, the method 300 may include iteratively selecting a next data line, at 304. If all data lines have been analyzed, at 320, the method 300 may include providing compiled compliance data, if any, at 322. For example, compliance data regarding applied rules may be generated and compiled at 318 and the resulting compiled compliance data may be sent to a device at 322.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, in the flow diagrams presented herein, in certain embodiments blocks may be removed or combined without departing from the scope of the disclosure. For example, elements 308 and 310 of FIG. 3 may be combined by iteratively retrieving rules from a database and comparing them to the current data line. Further, structural and functional elements within the diagram may be combined, in certain embodiments, without departing from the scope of the disclosure. For example, one or more of the modules of FIG. 2 may be combined, such as with a circuit configured to perform the functions of multiple modules. For example, certain modules and components may be combined, or split into sub-components. Functionality assigned to a particular component or module may be handled by another component instead. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A system comprising:
a processor configured to:
compare configuration data to a rule set;
generate compliance data based on the results of the comparison; and
generate a report including the compliance data.

2. The system of claim 1 wherein generating the report includes generating a graphical user interface (GUI) providing the compliance data.

3. The system of claim 1 comprising the processor further configured to:
iteratively select segments of the configuration data, each segment including a configuration parameter for a computing system;
compare each segment of the configuration data to the rule set; and
generate the compliance data including rule results for each segment that did not comply with the rule set.

4. The system of claim 3 comprising the processor further configured to:
compare each segment to the rule set, including iterating through a plurality of rules of the rule set for each segment.

5. The system of claim 1 comprising the processor further configured to:
compare the configuration data to the rule set, including:
retrieve reference data from a memory; and
compare the reference data to the configuration data according to the rule set.

6. The system of claim 1 wherein the rule set requires data to fall within a specified value range.

7. The system of claim 1 comprising the processor further configured to:
receive the configuration data at an interface;
determine a data format of the configuration data; and
convert the configuration data into a standard format.

8. The system of claim 7 comprising the processor further configured to:
determine whether the data format is among a plurality of recognized data formats for conversion into the standard format; and
output a notice that the data cannot be converted into the standard format when the data format is not among the recognized data formats.

9. A memory device storing instructions that, when executed, cause a processor to perform a method comprising:
normalizing unverified data by converting the unverified data to a selected format;
determining compliance data for the unverified data based on a rule set; and
reporting the results of the determination.

10. The memory device of claim 9, wherein the unverified data includes configuration data to select parameters for a computing system.

11. The memory device of claim 9 storing instructions that, when executed, cause a processor to perform a method further comprising:
iteratively selecting segments of the unverified data;
comparing each segment of the unverified data to the rule set; and
wherein the compliance data includes rule results for each segment that did not comply with the rule set.

12. The memory device of claim 11 storing instructions that, when executed, cause a processor to perform a method further comprising:
comparing each segment to the rule set, including iterating through a plurality of rules of the rule set for each segment.

13. The memory device of claim 9 storing instructions that, when executed, cause a processor to perform a method further comprising:
comparing the unverified data to the rule set, including:
retrieving reference data from a memory; and
comparing the reference data to the unverified data according to the rule set.

14. The memory device of claim 9, wherein the rule set requires data to fall within a specified value range.

15. The memory device of claim 9 wherein normalizing the unverified data includes:
receiving the unverified data at an interface;
determining a data format of the unverified data; and
converting the unverified data into the selected format.

16. The memory device of claim 9 storing instructions that, when executed, cause a processor to perform a method further comprising:
determining whether the data format is among a plurality of recognized data formats for conversion into the standard format; and
outputting a notice that the data cannot be converted into the selected format if the data format is not among the recognized data formats.

17. A method comprising:
normalizing unverified data by converting the unverified data to a selected format at a normalization module;
determining first compliance data for the unverified data based on a rule set at a rules module; and
reporting the results of the determination via an interface.

18. The method of claim 17 further comprising:
iteratively selecting segments of the unverified data;
comparing each segment of the unverified data to the rule set; and
wherein the first compliance data includes rule results for each segment that did not comply with the rule set.

19. The method of claim 17, wherein the unverified data includes configuration data to select parameters for a computing system.

20. The method of claim 17 wherein normalizing the unverified data includes:
determining second compliance data based on comparing the rule set to second unverified data received after the first unverified data;
determining if the second unverified data is more compliant with the rule set than the first unverified data based on a comparison of the first compliance data to the second compliance data.
